(19) United States
(12) Patent Application Publication
(10) Pub. No.: US 2011/0206819 A1
(43) Pub. Date: Aug. 25, 2011

(54) METHOD AND APPARATUS FOR MASS-PRODUCING PANCAKES, CREPES, ETC

(76) Inventors: Marc BRYSSE, Sint-Andries (BE); Peter Ohms, Brugge (BE)

(21) Appl. No.: 13/078,508

(22) Filed: Apr. 1, 2011

Related U.S. Application Data
(63) Continuation of application No. PCT/EP2010/053452, filed on Mar. 17, 2010.
Application No. PCT/EP2010/053452 is a continuation of application No. PCT/EP2009/062775, filed on Oct. 1, 2009.
(60) Provisional application No. 61/101,795, filed on Oct. 1, 2008.

(30) Foreign Application Priority Data
Oct. 1, 2008 (EP) 08165635.7

(51) Int. Cl. A21D 10/04; A21B 5/00; A23P 1/10

(52) U.S. Cl. 426/549; 99/432

(57) ABSTRACT

A process and apparatus for preparing a food product in the form of a sheet, having a selected shape and/or incorporating decorative designs/images are provided. The process includes pouring liquid batter on a heated surface to form a contour outline according to a desired shape, pouring liquid batter to form design lines within the contour outline, and pouring liquid batter within the contour outline to form a main surface of the food product.

### CROSS-REFERENCE TO RELATED APPLICATIONS

This application is a bypass continuation application of International Patent Application Nos. PCT/EP2010/053452 filed Mar. 17, 2010, and PCT/EP2009/062775 filed Oct. 1, 2009, the disclosures of which are incorporated herein by reference in their entirety. This application claims priority from International Patent Application No. PCT/EP2010/053452 filed Mar. 17, 2010, and International Patent Application No. PCT/EP2009/062775 filed Oct. 1, 2009, which claims priority from European Patent Application No. 08165635.7 and U.S. Provisional Application No. 61/101,795, both filed Oct. 1, 2008, the disclosures of which are incorporated herein by reference in their entirety.

### BACKGROUND

1. Field

Apparatuses and methods consistent with the present disclosure relate to the preparation of pancakes, crepes, and similar products, and more particularly to the mass production of food products in the form of sheets (e.g., pancakes, crepes, tortillas, “brick” pastry, etc.) having selected shapes and/or incorporating decorative designs/images.

2. Description of the Related Art

Food products such as pancakes, crepes, tortillas, brick pastry, and more generally food products in sheet form, are able to be mass produced. For example, reference can be made in this respect to U.S. 2008/0060531 (pancakes and the like), WO 2004/100672 (food products in the form of sheets such as sheets of brick pastry), EP 1 759 585 (sandwich pancakes), U.S. Pat. No. 3,993,788 (tortillas and similar products). Some known mass production methods involve imprinting artwork onto the food that is being cooked (U.S. 2008/0060531), or stamping a design on the outer surface of the product (EP 1 759 585).

However, printing or stamping decorative figures on food products is however a drawback in itself and the known techniques are generally not satisfactory for moist products like pancakes.

The mass production of shaped food products, using moulding shapes or shaped baking plates has on the other hand the drawback of being not optimally compatible with the rather liquid batters as used for Dutch, French or American type pancakes and crepes, and impairs the versatility of the method linked to such preset moulds.

In the context of mass producing decorated food products, it has also been proposed to associate at least two distinct dough compositions/portions, of distinct color and/or texture, which are baked simultaneously or after each other, such as in U.S. 2005/048182 A1 (King) and in WO 03/020043 A1 (NESTEC).

Home methods of preparing “designer” pancakes (i.e. pancakes having selected shapes and/or incorporating decorative designs or images) are known, however, such “artisanal” techniques are not suitable for mass production of “designer” food products in sheet form.

The mass production methods according to the related art for producing food products with a decorative pattern in particular present the drawback that the decorative patterns, and more specifically the outer shape of the finished product, do not define neat, well defined contours, which has been found to be highly desirable for a large part of the purchasing public.

### SUMMARY

Exemplary embodiments of the present disclosure overcome the above disadvantages and other disadvantages not described above. Also the present disclosure is not required to overcome the disadvantages described above, and an exemplary embodiment of the present disclosure may not overcome any of the problems described above.

The present disclosure provides a process for mass producing food products in the form of sheets having selected shapes and optionally incorporating decorative designs or images.

According to an exemplary embodiment, a method of preparing food products in the form of sheets having a selected shape and optionally incorporating decorative designs or images, includes pouring a liquid batter on a heated surface to form one or more batter lines defining at least one outer outline of the food product, and pouring liquid batter in an area within the at least one outer outline to form a main surface of the food product.

According to another exemplary embodiment, an apparatus for preparing food products in the form of sheets having a selected shape and optionally incorporating decorative designs or images, includes a first pouring unit that pours liquid batter in the form of one or more batter lines defining at least one outer outline of the food product, a heated sheet on which the one or more batter lines are formed, and a second pouring unit that pours liquid batter in an area within the at least one outer outline to form a main surface of the food product.

According to another exemplary embodiment, a method of providing a party kit, wherein the method includes pouring a liquid batter on a heated surface to form one or more batter lines defining at least one outer outline of a food product according to a them, pouring liquid batter in an area within the at least one outer outline to form a main surface of the food product according to the theme, packaging the food product with party supplies that are decorated according to the theme.

### BRIEF DESCRIPTION OF THE DRAWINGS

The above and/or other aspects of the present disclosure will become more apparent by describing certain exemplary embodiments of the present disclosure with reference to the accompanying drawings, in which:

FIG. 1 illustrates an example (character design of “Winnie the Pooh”) of a pancake obtained by using the process according to an exemplary embodiment;

FIG. 2 illustrates another example (character design of “Mickey Mouse”) of a pancake obtained by using the process according to an exemplary embodiment;

FIG. 3 illustrates an example of a party kit according to an exemplary embodiment.

FIG. 4 illustrates a method of preparing food products in the form of sheets having a selected shape according to an exemplary embodiment.

FIG. 5 illustrates an apparatus for preparing food products in the form of sheets having a selected shape according to an exemplary embodiment.

### DETAILED DESCRIPTION OF EXEMPLARY EMBODIMENTS

Exemplary embodiments of the present disclosure are described in greater detail below with reference to the accompanying drawings.

In the following description, like drawing reference numerals are used for the like elements, even in different drawings. The matters defined in the description, such as detailed construction and elements, are provided to assist in a comprehensive understanding of the invention. However, the present disclosure can be practiced without those specifically defined matters. Also, well-known functions or constructions are not described in detail since they would obscure the invention with unnecessary detail.

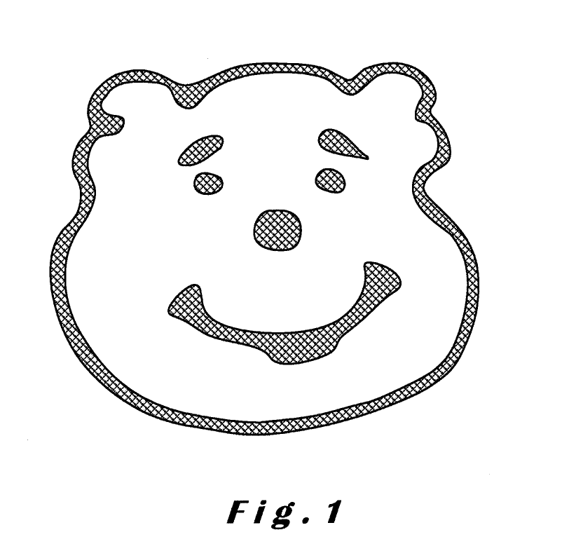

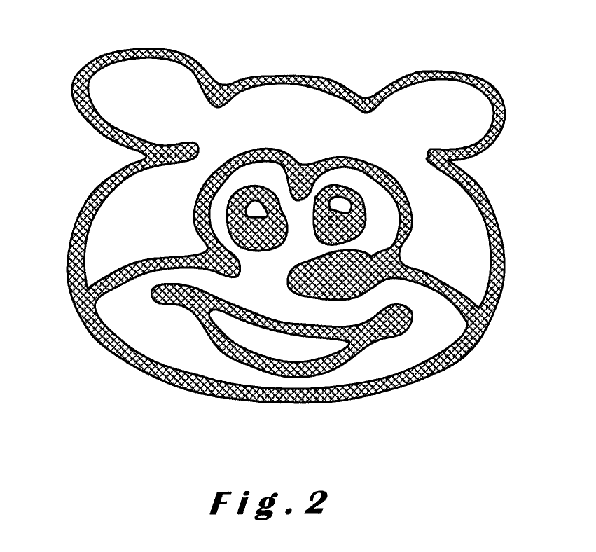

FIGS. 1 and 2 depict two examples of a pancake obtained using a process according to an exemplary embodiment, as will be described below. In FIG. 1, the process according to an exemplary embodiment creates an outer outline in the shape of “Winnie the Pooh,” and inner outlines corresponding to a mouth, nose, eyes, and eyebrows. As shown in FIG. 2, the process according to an exemplary embodiment creates an outer outline in the shape of “Mickey Mouse,” and inner outlines corresponding to a mouth, nose, and eyes.

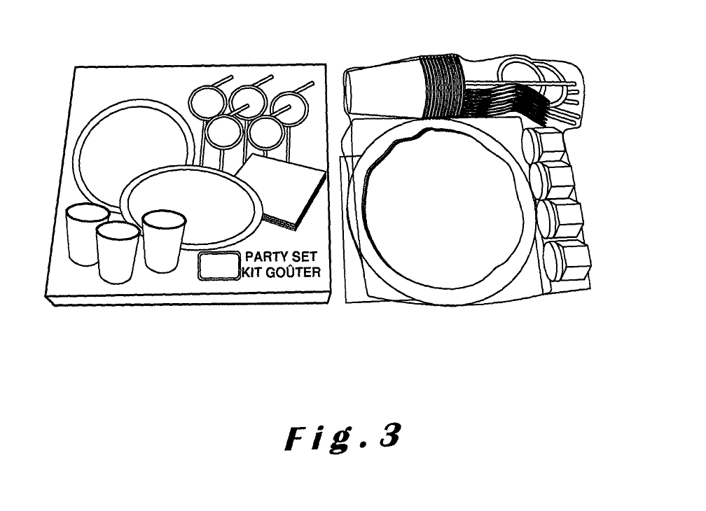

FIG. 3 depicts a party kit that includes pancakes made using a process according to an exemplary embodiment. As shown in FIG. 3, the party kit may include suitable accessories such as appropriately decorated (such as with corresponding and/or associated characters) table sheets, napkins, plates, cutlery, cups or beakers, etc., as well as drinks, pancake spreads and toppings, etc., further candies and sweets, further party accessories like party decoration, streamers, ticker tapes, etc. that correspond to a theme of the pancakes that are also included in the party kit. For example, if the pancakes are shaped in the form of “Whinnie the Pooh,” as shown in FIG. 1, the party supplies in the party kit also contain images or designs corresponding to the “Whinnie the Pooh” theme. Although FIG. 3 is described in the context of pancakes, other food products in the form of sheets may be used.

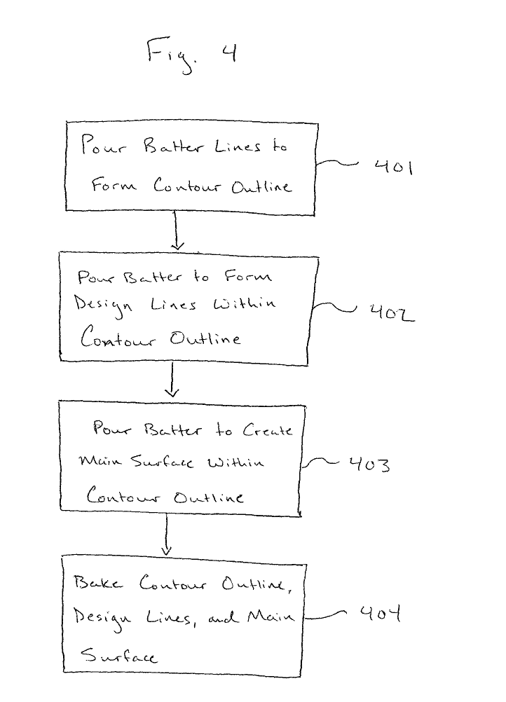

FIG. 4 depicts a flowchart illustrating a method of preparing food products in the form of sheets having a selected shape according to an exemplary embodiment.

As shown in FIG. 4, batter lines are poured on a heated surface to form a contour outline according to a desired shape in step 401. In step 402, design lines may be poured on the heated surface within the contour outline, according to a desired design. After allowing the batter lines and design lines to bake for a predetermined amount of time, in step 403 liquid batter is poured within the contour outline to create a main surface of the sheet shaped food product. In step 404, the batter forming the contour outline, design lines, and main surface are baked together.

According to an exemplary embodiment, a spray robot may be used to create the counter outline and/or design lines on the heated surface. The heated surface may be a flat surface, and may be heated to a temperature between 80° and 250° C., however the exemplary embodiments are not limited to this range. The heated surface may be stationary, may intermittently move, or may continuously move. For example, the heated surface may have an intermittently or continuously moving carrousel construction or an intermittently or continuously linear transfer construction.

The contour outline and/or design lines may be formed by continuous or broken batter lines. The batter lines may be any width, but are preferably less than 15 mm. The batter lines may be poured at a speed of approximately 50 g per 3 seconds. The batter lines used to form the outer contour and the liquid batter used to form the main surface may be made of the same batter composition.

The batter composition according to an exemplary embodiment may be as follows:

The amount of added liquid (in particular water, milk and/or the like) may be in the range of 25% by weight to 60% by weight of the total batter composition, with an optimum amount between 40% and 45% by weight.

The amount of added “fatty matter” may be in the range of 5% to 20% by weight of the total batter composition, with an optimum amount between 7% and 14% by weight. The term “fatty matter” refers to any fatty composition with a water content between 15% and 50%, such as fat, shortenings, margarine, so called “cocoline” products, etc.

The dry matter content may be in the range of 25% by weight to 40% by weight of the total batter composition, with an optimum amount of approximately 34% by weight. The term “dry matter” as used in this context refers to the essentially dry ingredients including more specifically flour, sugar, salt, and cacao powder. The flour may be any type of flour commonly used for pancakes, such as, preferably, wheat flour, but also buckwheat flour.

The proportion of “binder” (i.e. the flour) in the dry matter ingredients is preferably about 60% or above.

The expressions “added fatty matter” and “added liquid” as used in this context refer to the amount of fats and the amount of liquid added to the batter mass without taking into account any amounts of fat and/or liquid contained in other conventional ingredients of the batter composition, such as eggs, cacao mass, flour, sugar, salt, etc.

The batter composition may also include coloring substances and/or additives to cause the coloring or browning of baking products. In particular, the fraction of the batter which is used for building the contour batter outline and/or design batter lines may include coloring substances and/or browning additives to provide or enhance a distinct colouring thereof. The production of distinct colors may include the use of coloring substances (like cacao in particular or food grade colorants, food grade dyes, food grade inks, etc.) and/or additives favoring the coloring or browning of baking products (such as in particular reducing sugars).

According to an exemplary embodiment, the batter composition may include:

| | weight % |
|---|---|
| pastry flour | 21.7 |
| fine sugar | 7.7 |
| whole egg | 14.2 |
| liquid | 43.0 |
| salt | 0.2 |
| fat | 7.2 |
| baking powder | 0.1 |
| milk powder | 5.9 |
| total | 100.0 |

The batter lines and/or design lines may be poured on the heated surface using at least one pouring head or die disposed at a distance from the heated surface of less than 100 mm, preferably less than 50 mm, and most preferably less than 10 mm. The batter lines and/or design lines may be poured using a spraying robot having a die diameter of no more than 3 mm, most preferably between 0.61 mm and 0.84 mm.

The batter lines and/or design lines are allowed to bake for a predetermined amount of time before the liquid batter forming the main surface is poured. The predetermined time may be between 10 and 20 seconds, although is not limited thereto.

Pouring the amount of liquid batter to form the main surface within the outer contour and over/around said inner design lines, respectively, can be carried out using at least one static or moving pouring head or die, at least one toppling pouring cup or at least one shower type spray head after the batter outlines and/or design lines have been poured.

Alternatively, the batter lines used to form the outer contour and the liquid batter used to form the main surface may be made from different batter compositions.

In particular, the first batter used to form the outer contour and the second batter used to form the main surface may have different colors, different viscosity, different ability to resist burning or charring at a given temperature, and/or different bubbling characteristics at a given temperature. For example, the first batter and second batter may have different fat ratios, different liquid ratios, and/or different dry matter content. The liquid ratio of the batter influences the ability of the batter to resist the baking temperature, and the ability of the batter/dough to remain flexible upon baking. According to an exemplary embodiment, the first batter may not include a leavening agent, such as yeast or baking powder. According to an exemplary embodiment, the second batter may be more fluid than the than the first batter.

When different batter compositions are used for the first and second batters, the second batter may be poured within the outer contour before the design lines are poured.

According to an exemplary embodiment, the composition of the first batter used to form the outer contour and design lines may include:

| | weight (grams) | weight % |
|---|---|---|
| pastry flour | 615 | 29.36 |
| fine sugar | 62 | 2.96 |
| whole egg | 225 | 10.74 |
| liquid | 850 | 40.57 |
| salt | 6 | 0.29 |
| fat | 300 | 14.32 |
| cacao mass | 37 | 1.77 |
| total | 2,095 | 100.00 |

According to an exemplary embodiment, the composition of the second batter used to form the main surface of the food product may include:

| | weight % |
|---|---|
| pastry flour | 21.73 |
| fine sugar | 7.68 |
| whole egg | 14.19 |
| liquid | 43.06 |
| salt | 0.22 |
| fat | 7.15 |
| baking powder | 0.10 |
| milk powder | 5.87 |
| total | 100.00 |

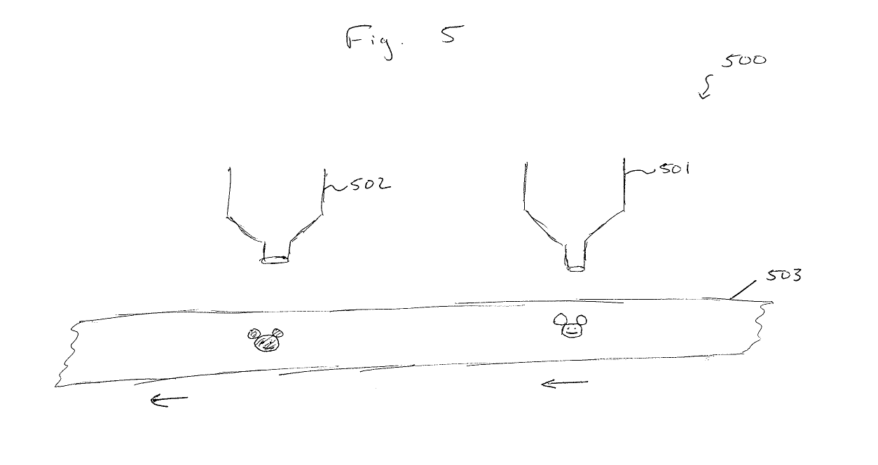

FIG. 5 illustrates an apparatus 500 for preparing food products in the form of sheets having a selected shape according to an exemplary embodiment. As shown in FIG. 5, a first batter dispensing unit 501 dispenses liquid batter on a heated surface 503 to form a contour outline according to a desired shape. The first batter dispensing unit 501 also dispenses liquid batter within the contour outline to form design lines according to a desired design. After the contour outline and design lines have been formed by the liquid batter, the heated surface 503 transports the contour outline to a second batter dispensing unit 502, which dispenses liquid batter within the contour outline to create a main surface of the sheet shaped food product.

The heated surface 503 may be a flat surface, and may be heated to a temperature between 80° and 250° C., however the exemplary embodiments are not limited to this range. The heated surface 503 may be stationary, may intermittently move, or may continuously move. For example, the heated surface may have an intermittently or continuously moving carrousel construction or an intermittently or continuously linear transfer construction.

The first batter dispensing unit 501 may include a pouring head or die disposed at a distance from the heated surface 503 of less than 100 mm, preferably less than 50 mm, and most preferably less than 10 mm. The second batter dispensing unit 502 may include a static or moving pouring head or die, at least one toppling pouring cup or at least one shower type spray head.

The apparatus 500 may also include a flour silo, a dough preparation unit, a sprayer for spraying oil, a transfer unit to transfer the food product from the heated surface to a transport unit, a cooling tunnel for cooling the pancakes to minimum 0° C. and/or a freezing unit for deep freezing the pancakes to −22° C., a piling unit for piling up the pancakes, and a packaging unit.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for preparing a food product in the form of a sheet, having a selected shape, the method comprising:
pouring a first liquid batter on a heated surface to form at least one outer outline according to the selected shape; and
pouring a second liquid batter on the heated surface within the at least one outer outline to form a main surface of the food product according to a selected design.

2. The method according to claim 1, further comprising:
pouring the first liquid batter on a heated surface within the at least one outer outline to form at least one design line according to the selected design.

3. The method according to claim 1, wherein the at least one outer outline is a continuous outline.

4. The method according to claim 2, wherein the at least one design line is a continuous line.

5. The method according to claim 2, wherein the design lines are poured before the second liquid batter is poured.

6. The method according to claim 1, wherein the first liquid batter and the second liquid batter are made from the same batter composition.

7. The method according to claim 1, wherein the heated surface is heated to a temperature between 80° and 250° C., and the at least one outer outline has a width less than 15 mm.

8. The method according to claim 1, wherein the first liquid batter comprises a coloring substance that causes the at least one outer outline to be a different color than a color of the main surface.

9. The method according to claim 1, wherein the pouring of the first liquid batter is controlled by a spray-robot, and the heated surface moves continuously or intermittently.

10. The method according to claim 2, wherein the first liquid batter and the second liquid batter are made from different batter compositions.

11. The method according to claim 10, wherein the second liquid batter that forms a main surface is poured before the first liquid batter that forms the at least one design line.

12. The method according to claim 10, wherein the first liquid batter and the second liquid batter have different fat ratios or different water ratios.

13. The method according to claim 10, wherein the first liquid batter does not include a leavening agent.

14. The method according to claim 10, wherein a batter composition used to make the first liquid batter comprises:
an amount of added liquid between 25% by weight and 60% by weight of the batter composition;
an amount of added fat between 7% by weight and 20% by weight of the batter composition; and
a dry matter content between 25% by weight and 40% by weight of the batter composition.

15. An apparatus for producing a food product in the form of sheets having a selected shape, the apparatus comprising:
a first batter dispensing unit that dispenses first liquid batter forming at least one outer outline according to the selected shape;
a second batter dispensing unit that dispenses second liquid batter within the at least one outer outline to form a main surface of the food product according to a selected design; and
a heated surface which receives and transports the first liquid batter forming the at least one outer outline to the second batter dispensing unit, and receives the second liquid batter.

16. The apparatus according to claim 15, wherein the first batter dispensing unit dispenses the first liquid batter on the heated surface within the at least one outer outline to form at least one design line according to the selected design.

17. The apparatus according to claim 15, wherein the first batter dispensing unit dispenses the first liquid batter so that the at least one outer outline has a width less than 15 mm.

18. The apparatus according to claim 15, wherein at least one of the first batter dispensing unit and the second batter dispensing unit comprise a pouring head or die disposed at a distance from the heated surface of less than 100 mm.

19. The apparatus according to claim 15, wherein the heated surface is heated to a temperature between 80° and 250° C.

20. A method of producing a party kit according to a theme, the method comprising:
pouring a first liquid batter on a heated surface to form at least one outer outline according to the theme; and
pouring a second liquid batter on the heated surface within the at least one outer outline to form a main surface of a food product according to the theme;
packaging the food product with party supplies according to the theme.
